(19) United States
(12) Patent Application Publication
(10) Pub. No.: US 2026/0088534 A1
(43) Pub. Date: Mar. 26, 2026

(54) CONNECTOR, PLUG CONNECTOR, RECEPTACLE CONNECTOR, CONNECTOR ASSEMBLY, AND METHOD FOR MANUFACTURING CONNECTOR

(71) Applicant: HIROSE ELECTRIC CO., LTD., Kanagawa (JP)

(72) Inventor: Kouhei ODA, Kanagawa (JP)

(21) Appl. No.: 19/337,226

(22) Filed: Sep. 23, 2025

(30) Foreign Application Priority Data
Sep. 25, 2024 (JP) 2024-166448

(51) Int. Cl. H01R 12/71; H01R 12/70; H01R 13/05; H01R 13/11; H01R 13/50; H01R 43/18; H01R 43/20

(52) U.S. Cl. CPC H01R 12/716; H01R 13/055; H01R 13/113; H01R 13/50; H01R 43/18; H01R 43/205; H01R 12/707

(57) ABSTRACT

Provided is a connector mounted on a circuit board, including: a first terminal and a second terminal; and a housing having a holding portion, in which the first terminal and the second terminal are arranged in a longitudinal direction of the holding portion, and extend in a lateral direction of the holding portion, the first terminal includes a first mount portion, the second terminal includes a second mount portion and a non-mount portion, and the non-mount portion is not mounted on the circuit board in a state of the connector being mounted on the circuit board, the first mount portion and the non-mount portion extend outward of the connector from the holding portion along the lateral direction, and the housing has an insulating member, and the insulating member is interposed between the first mount portion and the non-mount portion, which are adjacent to each other in the longitudinal direction.

### CROSS-REFERENCE TO RELATED APPLICATION

This application claims priority from Japanese Patent Application No. 2024-166448 filed with the Japan Patent Office on Sep. 25, 2024, the entire content of which is hereby incorporated by reference.

### BACKGROUND

### 1. Technical Field

The present disclosure relates to a connector, a plug connector, a receptacle connector, a connector assembly, and a method for manufacturing the connector.

### 2. Related Art

Conventionally, various connectors mounted on circuit boards have been proposed. For example, a connector described in JP-A-2023-118511 includes a first terminal and a second terminal arranged in the width direction of the connector, each of the first terminal and the second terminal includes a mount portion mounted on a circuit board in a state of the connector being mounted on the circuit board, and the second terminal includes a non-mount portion not mounted on the circuit board in a state of the connector being mounted on the circuit board.

### SUMMARY

A connector according to the present disclosure is mounted on a circuit board. The connector includes: a first terminal and a second terminal; and a housing having a holding portion for holding the first terminal and the second terminal. In the connector, the first terminal and the second terminal are arranged in a longitudinal direction of the holding portion, and extend in a lateral direction of the holding portion, the first terminal includes a first mount portion, the second terminal includes a second mount portion, and the first mount portion and the second mount portion are mounted on the circuit board in a state of the connector being mounted on the circuit board, the second terminal further includes a non-mount portion, and the non-mount portion is not mounted on the circuit board in the state of the connector being mounted on the circuit board, the first mount portion of the first terminal and the non-mount portion of the second terminal extend outward of the connector from the holding portion along the lateral direction, and the housing has an insulating member, and the insulating member is interposed between the first mount portion of the first terminal and the non-mount portion of the second terminal, which are adjacent to each other in the longitudinal direction.

### BRIEF DESCRIPTION OF THE DRAWINGS

FIG. 1 is a perspective view of a plug connector;

FIG. 2 is a perspective view of a receptacle connector;

FIG. 3 is a perspective view of the receptacle connector and the plug connector;

FIG. 4 is a perspective view of the receptacle connector and the plug connector;

FIG. 5 is an exploded perspective view of the receptacle connector;

FIG. 6 is a perspective view of the receptacle connector;

FIG. 7 is a perspective view of the receptacle connector;

FIG. 8 is a perspective view of the receptacle connector;

FIG. 9 is a plan view of the receptacle connector;

FIG. 10 is a sectional view taken along A-A line of FIG. 9;

FIG. 11 is a sectional view taken along B-B line of FIG. 9;

FIG. 12 is an exploded perspective view of the plug connector;

FIG. 13 is a perspective view of the plug connector;

FIG. 14 is a perspective view of the plug connector;

FIG. 15 is a perspective view of the plug connector;

FIG. 16 is a plan view of the plug connector;

FIG. 17 is a sectional view taken along A-A line of FIG. 16;

FIG. 18 is a sectional view taken along B-B line of FIG. 16;

FIG. 19 is a side view of the receptacle connector and the plug connector;

FIG. 20 is a sectional view taken along A-A line of FIG. 19;

FIG. 21 is a sectional view taken along B-B line of FIG. 19;

FIG. 22 is a view showing a process of manufacturing the receptacle connector;

FIG. 23 is a view showing the process of manufacturing the receptacle connector;

FIG. 24 is a view showing the process of manufacturing the receptacle connector;

FIG. 25 is a view showing the process of manufacturing the receptacle connector;

FIG. 26 is a view showing the process of manufacturing the receptacle connector;

FIG. 27 is a view showing a process of manufacturing the plug connector;

FIG. 28 is a view showing the process of manufacturing the plug connector;

FIG. 29 is a view showing the process of manufacturing the plug connector;

FIG. 30 is a view showing the process of manufacturing the plug connector; and

FIG. 31 is a view showing the process of manufacturing the plug connector.

### DETAILED DESCRIPTION

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

However, in the connector described in JP-A-2023-118511, the tip end of the non-mount portion of the second terminal is not covered by the insulating member, but is exposed. For this reason, there is a possibility of short circuit occurring between the first terminal and the second terminal. Particularly, in recent years, size reduction in a connector has been further demanded, and tendency shows that a distance between terminals is shorter. This leads to a problem that the short circuit easily occurs between the first terminal and the second terminal.

The present disclosure has been made in view of such a situation, and one object thereof is to provide a connector, a plug connector, a receptacle connector, a connector assembly, and a method for manufacturing the connector, which can reduce occurrence of short circuit between terminals.

A connector according to an aspect of the present disclosure is mounted on a circuit board. The connector includes: a first terminal and a second terminal; and a housing having a holding portion for holding the first terminal and the second terminal. In the connector, the first terminal and the second terminal are arranged in a longitudinal direction of the holding portion, and extend in a lateral direction of the holding portion, the first terminal includes a first mount portion, the second terminal includes a second mount portion, and the first mount portion and the second mount portion are mounted on the circuit board in a state of the connector being mounted on the circuit board, the second terminal further includes a non-mount portion, and the non-mount portion is not mounted on the circuit board in the state of the connector being mounted on the circuit board, the first mount portion of the first terminal and the non-mount portion of the second terminal extend outward of the connector from the holding portion along the lateral direction, and the housing has an insulating member, and the insulating member is interposed between the first mount portion of the first terminal and the non-mount portion of the second terminal, which are adjacent to each other in the longitudinal direction.

A method for manufacturing a connector according to an aspect of the present disclosure includes: holding, by a holding portion of a housing, a first terminal and a second terminal such that the first terminal and the second terminal are arranged in a longitudinal direction of the holding portion; and interposing an insulating member between a mount portion of the first terminal extending outward of the connector from the holding portion along a lateral direction of the holding portion and mounted on the circuit board in a state of the connector being mounted on the circuit board and a non-mount portion of the second terminal extending outward of the connector from the holding portion along the lateral direction of the holding portion and not mounted on the circuit board in the state of the connector being mounted on the circuit board.

According to the present disclosure, the occurrence of the short circuit between the terminals can be reduced.

Hereinafter, one embodiment of a connector assembly of the present disclosure will be described with reference to the drawings. Note that hereinafter, for the sake of convenience in description of the specification, the lateral direction (width direction) of the connector assembly may be described as an X-axis direction, the longitudinal direction (depth direction) of the connector assembly may be described as a Y-axis direction, and the height direction (thickness direction) of the connector assembly may be described as a Z-axis direction.

The connector assembly of the present embodiment includes a receptacle connector 200 as one example of a connector mounted on a first circuit board (not shown), and a plug connector 100 mounted on a second circuit board (not shown). The plug connector 100 is one example of a partner connector to be fitted in the receptacle connector 200. The connector assembly can be used as an internal component in a small electronic device such as a mobile phone, a smart phone, a digital camera, or a laptop computer. The connector assembly is configured such that the dimension thereof in the Z-axis direction which is the height direction is 1 mm or less (as one example, about 0.5 mm) and the dimensions thereof in the X-axis direction and the Y-axis direction are 5 mm or less (as one example, about 4 mm) although these dimensions depend on the number of terminals described later, for example.

Hereinafter, the surface of the plug connector 100 on the side on which the plug connector 100 is mounted on the second circuit board will be described as a lower surface, and the surface of the plug connector 100 on the side on which the plug connector 100 is fitted in the receptacle connector 200 will be described as an upper surface. Moreover, the surface of the receptacle connector 200 on the side on which the receptacle connector 200 is mounted on the first circuit board will be described as a lower surface, and the surface of the receptacle connector 200 on the side on which the receptacle connector 200 is fitted in the plug connector 100 will be described as an upper surface.

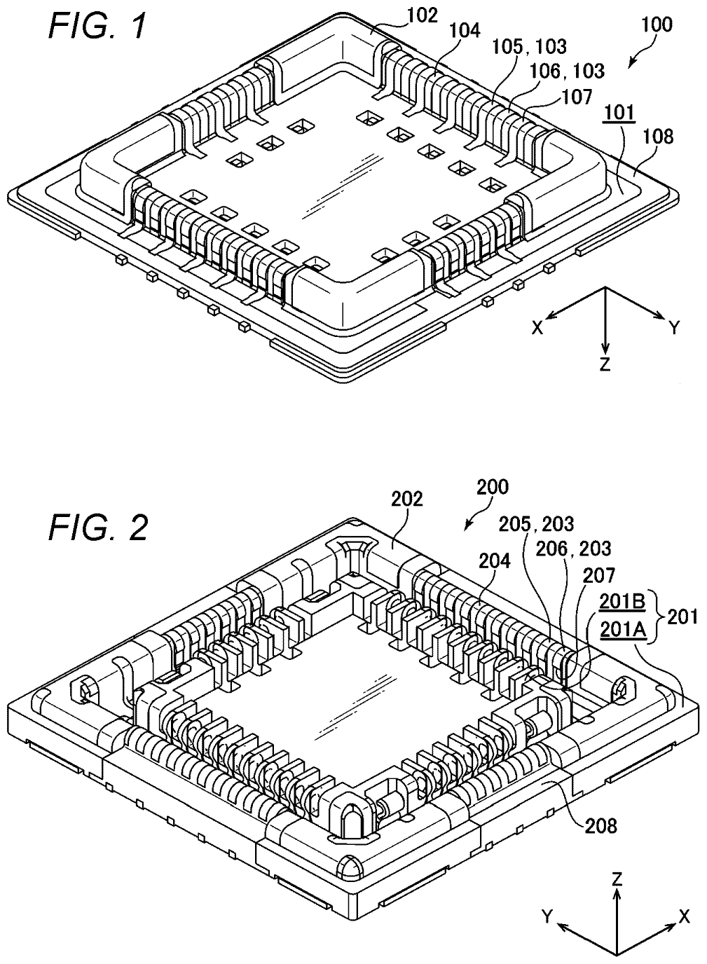

As shown in FIG. 1, the plug connector 100 includes a plug housing 101 in a rectangular plate shape with the Z-axis direction as a thickness direction. The plug housing 101 is one example of a holding member, and is made of resin such as liquid crystal polymer (LCP).

A plug raised portion 102 in a rectangular annular shape is provided so as to protrude along the Z-axis direction from the lower surface of the plug housing 101.

On each side (four sides) of the plug raised portion 102 extending in the X-axis direction or the Y-axis direction, a plug holding portion 104 for holding a plurality of plug terminals 103 is provided.

The plurality of plug terminals 103 includes a plurality of first plug terminals 105 and a plurality of second plug terminals 106 formed of conductive members of copper alloy or the like. The plurality of first plug terminals 105 and the plurality of second plug terminals 106 extend in the lateral direction of the plug holding portion 104, and are alternately arranged in the longitudinal direction of the plug holding portion 104. Each of the first plug terminals 105 and the second plug terminals 106 has a fitting raised portion 107 protruding in the Z-axis direction and formed substantially in an inverted U-shape.

At an outer edge portion of the plug housing 101, an insulating member 108 made of resin such as liquid crystal polymer (LCP) is provided over the entire area of each side of the plug housing 101. The insulating member 108 is provided so as to expose the tip end surfaces 105a of the first plug terminals 105 and cover the tip end surfaces 106a of the second plug terminals 106. The insulating member 108 is interposed, in the lateral direction of the plug holding portion 104, between the tip end surfaces 105a of the first plug terminals 105 and the tip end surfaces 106a of the second plug terminals 106 (see FIG. 12 and the like).

As shown in FIG. 2, the receptacle connector 200 includes a receptacle housing 201 in a rectangular plate shape with the Z-axis direction as a thickness direction. The receptacle housing 201 includes a first receptacle housing unit 201A and a second receptacle housing unit 201B.

The first receptacle housing unit 201A is made of resin such as liquid crystal polymer (LCP). A receptacle raised portion 202 in a rectangular annular shape is provided so as to protrude along the Z-axis direction from the upper surface of the first receptacle housing unit 201A.

On each side of the receptacle raised portion 202 extending in the X-axis direction or the Y-axis direction, the second receptacle housing unit 201B is provided. The second receptacle housing unit 201B has a receptacle holding portion 204 for holding a plurality of receptacle terminals 203.

The plurality of receptacle terminals 203 includes a plurality of first receptacle terminals 205 and a plurality of second receptacle terminals 206 formed of conductive members of copper alloy or the like. The plurality of first receptacle terminals 205 and the plurality of second receptacle terminals 206 extend in the lateral direction of the receptacle holding portion 204, and are alternately arranged in the longitudinal direction of the receptacle holding portion 204. Each of the first receptacle terminals 205 and the second receptacle terminals 206 has a fitting recessed portion 207 substantially in a U-shape opened in the Z-axis direction.

At an outer edge portion of the second receptacle housing unit 201B, an insulating member 208 made of resin such as liquid crystal polymer (LCP) is provided. The insulating member 208 is provided so as to expose the tip end surfaces 205a of the first receptacle terminals 205 and cover the tip end surfaces 206a of the second receptacle terminals 206. The insulating member 208 is interposed, in the lateral direction of the receptacle holding portion 204, between the tip end surfaces 205a of the first receptacle terminals 205 and the tip end surfaces 206a of the second receptacle terminals 206 (see FIG. 5 or the like).

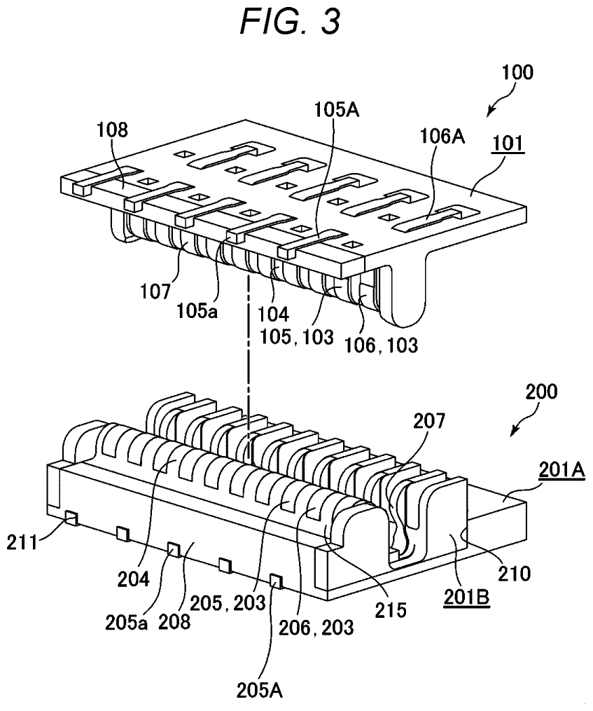

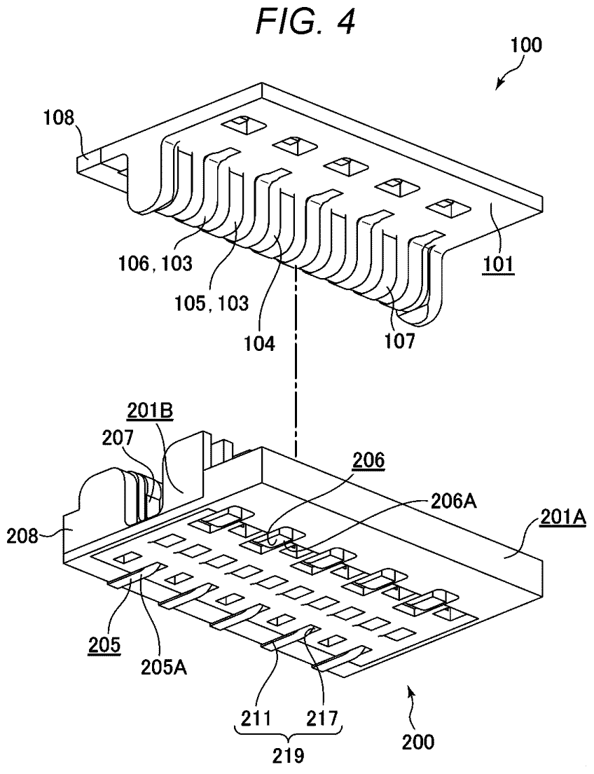

As shown in FIGS. 3 and 4, the fitting recessed portion 207 of each of the plurality of receptacle terminals 203 of the receptacle connector 200 and the fitting raised portion 107 of each of the plurality of plug terminals 103 of the plug connector 100 are fitted in each other in the Z-axis direction. The receptacle terminals 203 of the receptacle connector 200 and the plug terminals 103 of the plug connector 100 contact each other, and in this manner, the plug connector 100 and the receptacle connector 200 are electrically connected to each other.

As shown in FIG. 5, the receptacle housing 201 of the receptacle connector 200 is formed in such a manner that the first receptacle housing unit 201A is insert-molded with the second receptacle housing unit 201B. A front wall portion (outer wall) of the first receptacle housing unit 201A functions as the insulating member 208 made of resin such as liquid crystal polymer (LCP).

In side view in the lateral direction of the receptacle holding portion 204, the insulating member 208 is in a rectangular shape. In the lower surface of the insulating member 208, a plurality of first receptacle recessed portions 211 is formed at intervals in the longitudinal direction of the receptacle holding portion 204. Each of the plurality of first receptacle recessed portions 211 is formed at a position corresponding to each of the plurality of first receptacle terminals 205 in the longitudinal direction of the receptacle holding portion 204.

The receptacle holding portion 204 of the second receptacle housing unit 201B holds the plurality of first receptacle terminals 205 and the plurality of second receptacle terminals 206. In a front wall portion 215 of the receptacle holding portion 204 of the second receptacle housing unit 201B, a plurality of first receptacle penetrating portions 216 is formed so as to penetrate the front wall portion 215 in the thickness direction thereof. Each of the plurality of first receptacle penetrating portions 216 is formed at a position corresponding to each of the plurality of second receptacle terminals 206 in the longitudinal direction of the receptacle holding portion 204.

In the lower surface of the front wall portion 215 of the receptacle holding portion 204 of the second receptacle housing unit 201B, a plurality of second receptacle recessed portions 217 is formed at intervals in the longitudinal direction of the receptacle holding portion 204. Each of the plurality of second receptacle recessed portions 217 is formed at a position corresponding to each of the plurality of first receptacle terminals 205 in the longitudinal direction of the receptacle holding portion 204.

When the front wall portion 215 of the second receptacle housing unit 201B is covered with the insulating member 208 of the first receptacle housing unit 201A, the plurality of second receptacle recessed portions 217 of the second receptacle housing unit 201B and the plurality of first receptacle recessed portions 211 of the insulating member 208 form a plurality of third receptacle recessed portions 219 (see FIG. 8 and the like). The third receptacle recessed portion 219 is in a long groove shape extending long in the lateral direction of the receptacle holding portion 204.

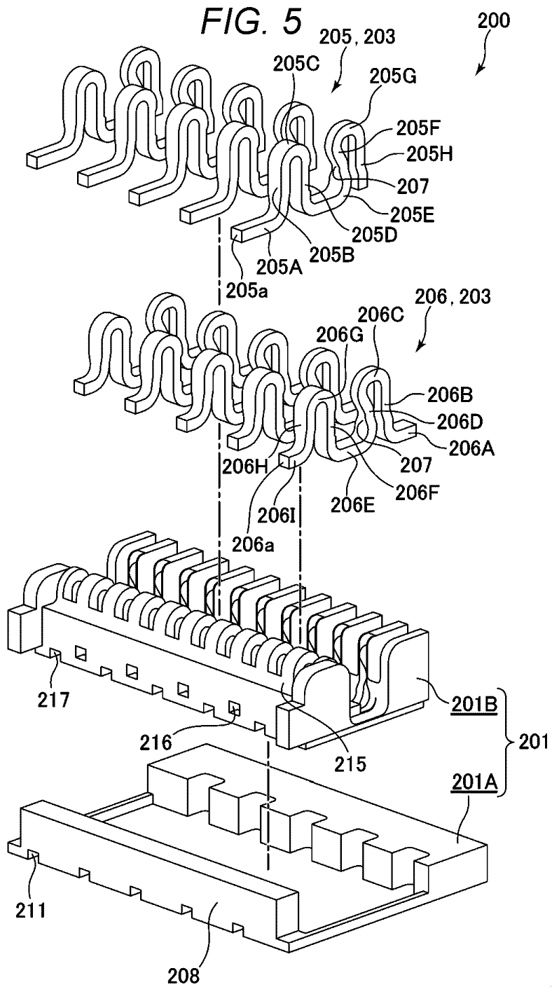

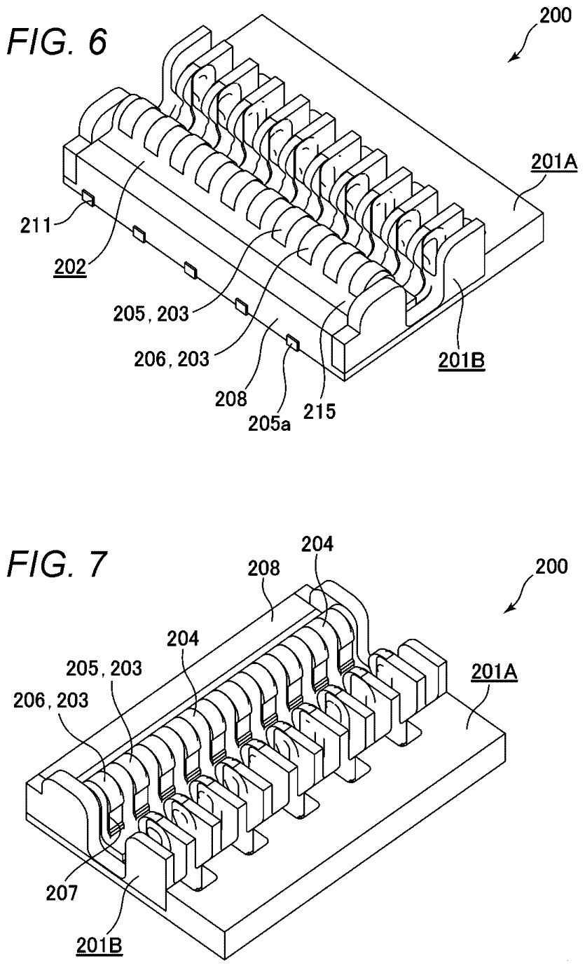

As shown in FIGS. 6 to 8, each of the plurality of third receptacle recessed portions 219 linearly extends outward of the receptacle connector 200 in the lateral direction of the receptacle holding portion 204, linearly penetrates the insulating member 208 outward of the receptacle connector 200, and is opened in the outer surface of the receptacle connector 200 of which the insulating member 208 is covered. In plan view in the Z-axis direction, each of the plurality of third receptacle recessed portions 219 is provided at a position corresponding to the first receptacle terminal 205.

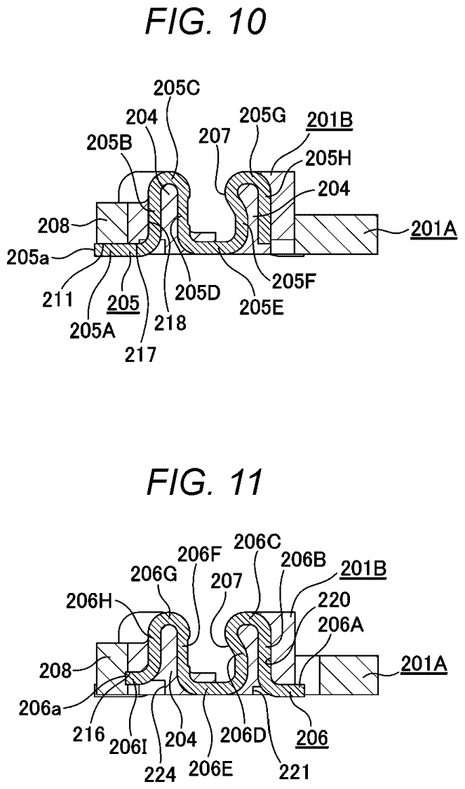

A second receptacle penetrating portion 218 penetrating the second receptacle housing unit 201B in the Z-axis direction is connected to the bottom surface of each of the plurality of third receptacle recessed portions 219 (see FIG. 10 and the like).

A tip end side (outer) portion of the first receptacle terminal 205 with respect to a portion held by the receptacle holding portion 204 is inserted into the second receptacle penetrating portion 218 in the Z-axis direction, is drawn to the lower surface of the receptacle housing 201, and is housed in the third receptacle recessed portion 219. The portion of the first receptacle terminal 205 housed in the third receptacle recessed portion 219 is flush with the lower surface of the first receptacle housing unit 201A, and as described later, when the first circuit board is mounted on the lower surface of the first receptacle housing unit 201A, functions as a mount portion 205A mounted on the first circuit board.

The outer tip end portion of the first receptacle terminal 205 protrudes outward of the receptacle connector 200 from the insulating member 208 in the lateral direction of the receptacle holding portion 204, and is exposed on the insulating member 208.

A tip end side (inner) portion of the second receptacle terminal 206 with respect to a portion held by the receptacle holding portion 204 is inserted into each of a plurality of third receptacle penetrating portions 220 penetrating the second receptacle housing unit 201B in the Z-axis direction.

The tip end surface 206a of a portion of the second receptacle terminal 206 on the outside of the receptacle connector 200 with respect to the portion held by the receptacle holding portion 204 is covered with the insulating member 208.

In the lower surface of the first receptacle housing unit 201A, a plurality of fourth receptacle recessed portions 221 is provided. The fourth receptacle recessed portion 221 is in a long groove shape extending long in the lateral direction of the receptacle holding portion 204. In plan view in the Z-axis direction, each of the plurality of fourth receptacle recessed portions 221 is provided at a position corresponding to the second receptacle terminal 206. The third receptacle penetrating portion 220 is connected to the bottom surface of each of the plurality of fourth receptacle recessed portions 221.

Each of the plurality of fourth receptacle recessed portions 221 linearly extends in the lateral direction of the receptacle holding portion 204 from a portion formed with the third receptacle penetrating portion 220. The tip end side (inner) portion of the second receptacle terminal 206 with respect to the portion held by the receptacle holding portion 204 is inserted into the third receptacle penetrating portion 220 in the Z-axis direction, is drawn to the lower surface of the receptacle housing 201 of the receptacle connector 200, and is housed in the fourth receptacle recessed portion 221. The portion of the second receptacle terminal 206 housed in the fourth receptacle recessed portion 221 is flush with the lower surface of the receptacle housing 201, and as described later, when the first circuit board is mounted on the lower surface of the receptacle housing 201, functions as a mount portion 206A mounted on the first circuit board.

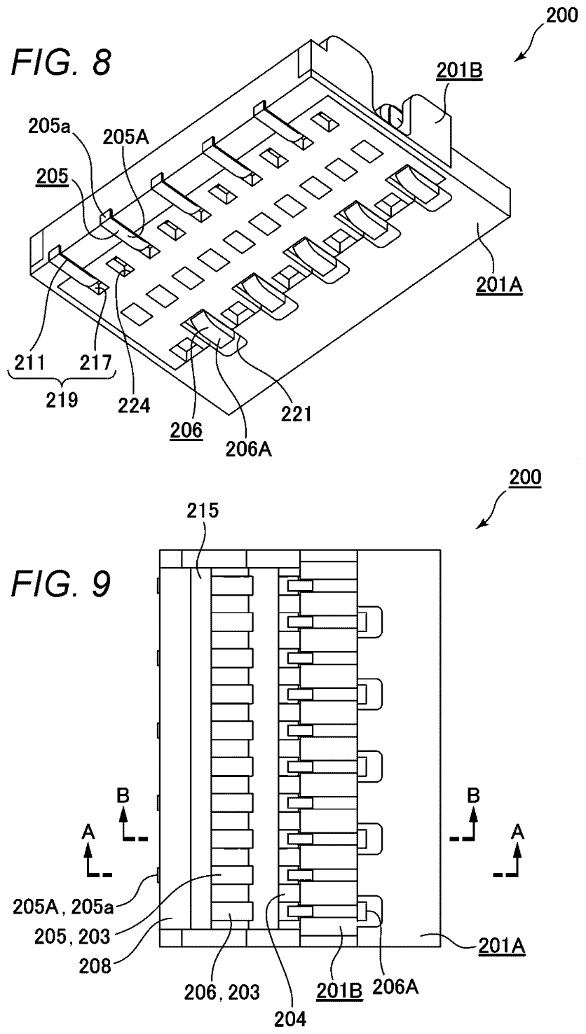

As shown in FIGS. 9 and 10, the first receptacle terminal 205 has the mount portion 205A, a first leg portion 205B, a first top portion 205C, a second leg portion 205D, a bottom portion 205E, a third leg portion 205F, a second top portion 205G, and a fourth leg portion 205H. The second leg portion 205D, the bottom portion 205E, and the third leg portion 205F form the fitting recessed portion 207 formed substantially in the U-shape and opened in the Z-axis direction.

The mount portion 205A is exposed on the receptacle housing 201 through the third receptacle recessed portion 219 formed in the lower surface of the receptacle housing 201, and is mountable on the first circuit board by soldering. The first leg portion 205B is coupled to the mount portion 205A, and extends in the Z-axis direction from the mount portion 205A. The first top portion 205C is coupled to the first leg portion 205B, and extends inward of the receptacle connector 200 from the first leg portion 205B along the lateral direction of the receptacle holding portion 204. The second leg portion 205D is coupled to the first top portion 205C, and extends in the Z-axis direction from the first top portion 205C.

The bottom portion 205E is coupled to the second leg portion 205D, and extends inward of the receptacle connector 200 from the second leg portion 205D along the lateral direction of the receptacle holding portion 204.

The third leg portion 205F is coupled to the bottom portion 205E, and extends in the Z-axis direction from the bottom portion 205E. The second top portion 205G is coupled to the third leg portion 205F, and extends inward of the receptacle connector 200 from the third leg portion 205F along the lateral direction of the receptacle holding portion 204. The fourth leg portion 205H is coupled to the second top portion 205G, and extends in the Z-axis direction from the second top portion 205G.

As shown in FIGS. 9 and 11, the second receptacle terminals 206 has the mount portion 206A, a first leg portion 206B, a first top portion 206C, a second leg portion 206D, a bottom portion 206E, a third leg portion 206F, a second top portion 206G, a fourth leg portion 206H, and a non-mount portion 206I. The second leg portion 206D, the bottom portion 206E, and the third leg portion 206F form the fitting recessed portion 207 formed substantially in the U-shape and opened in the Z-axis direction.

The mount portion 206A is exposed on the first receptacle housing unit 201A through the fourth receptacle recessed portion 221 formed in the lower surface of the first receptacle housing unit 201A, and is mounted on the first circuit board by soldering. The first leg portion 206B is coupled to the mount portion 206A, and extends in the Z-axis direction from the mount portion 206A. The first top portion 206C is coupled to the first leg portion 206B, and extends outward of the receptacle connector 200 from the first leg portion 206B along the lateral direction of the receptacle holding portion 204. The second leg portion 206D is coupled to the first top portion 206C, and extends in the Z-axis direction from the first top portion 206C.

The bottom portion 206E is coupled to the second leg portion 206D, and extends outward of the receptacle connector 200 from the second leg portion 206D along the lateral direction of the receptacle holding portion 204.

The third leg portion 206F is coupled to the bottom portion 206E, and extends in the Z-axis direction from the bottom portion 206E. The second top portion 206G is coupled to the third leg portion 206F, and extends outward of the receptacle connector 200 from the third leg portion 206F along the lateral direction of the receptacle holding portion 204. The fourth leg portion 206H is coupled to the second top portion 206G, and extends in the Z-axis direction from the second top portion 206G.

The non-mount portion 206I is coupled to the fourth leg portion 206H, and extends outward of the receptacle connector 200 from the fourth leg portion 206H in the lateral direction of the receptacle holding portion 204. The non-mount portion 206I is located apart from the first circuit board than the mount portion 206A in the Z-axis direction.

The non-mount portion 206I is exposed on the receptacle housing 201 through a fifth receptacle recessed portion 224 formed in the receptacle housing 201. However, a gap is interposed between the non-mount portion 206I and the first circuit board in the Z-axis direction, and therefore, the non-mount portion 206I is not mounted on the first circuit board (see FIG. 11).

As described above, the first receptacle terminals 205 and the second receptacle terminals 206 are arranged at intervals in the longitudinal direction of the receptacle holding portion 204. The first receptacle terminal 205 has, at the outer tip end thereof, the mount portion 205A (tip end surface 205a) (see FIG. 10). The second receptacle terminal 206 has, at the outer tip end thereof, the non-mount portion 206I (tip end surface 206a), and at the inner tip end thereof, has the mount portion 206A (see FIG. 11). The mount portions 205A of the first receptacle terminals 205 and the non-mount portions 206I of the second receptacle terminals 206 are adjacent to each other at intervals in the longitudinal direction of the receptacle holding portion 204, and extend outward of the receptacle connector 200 from the receptacle holding portion 204 in the lateral direction of the receptacle holding portion 204.

The tip end surface 205a of the first receptacle terminal 205 penetrates the insulating member 208 through the third receptacle recessed portion 219, and is exposed on the outer surface side of the receptacle connector 200. The mount portion 205A is exposed on the lower surface side of the receptacle connector 200 through the third receptacle recessed portion 219. Note that the outer surface of the receptacle connector 200 is the outer surface of the receptacle housing 201, specifically the outer surface of the receptacle housing 201 orthogonal to the lateral direction of the receptacle holding portion 204 (see FIG. 8 and the like).

The tip end surface 206a of the second receptacle terminal 206 is covered with the insulating member 208 on such an outer surface side of the receptacle connector 200. The non-mount portion 206I of the second receptacle terminal 206 has the gap with the first circuit board in the Z-axis direction in a state of the receptacle connector 200 being mounted on the first circuit board, and is formed so as not to contact the first circuit board (see FIG. 11 and the like).

As shown in FIG. 12, the plug holding portion 104 of the plug housing 101 of the plug connector 100 holds the plurality of first plug terminals 105 and the plurality of second plug terminals 106.

In the lower surface of the plug housing 101, a plurality of first plug recessed portions 109 is formed at intervals in the longitudinal direction of the plug holding portion 104. Each of the plurality of first plug recessed portions 109 is formed at a position corresponding to each of the plurality of first plug terminals 105 in the longitudinal direction of the plug holding portion 104.

In the upper surface of the plug housing 101, a plurality of second plug recessed portions 110 is formed at intervals in the longitudinal direction of the plug holding portion 104. Each of the plurality of second plug recessed portions 110 is formed at a position corresponding to each of the plurality of second plug terminals 106 in the longitudinal direction of the plug holding portion 104.

The insulating member 108 is in a rectangular columnar shape extending long in the longitudinal direction of the plug holding portion 104. In the lower surface of the insulating member 108, a plurality of third plug recessed portions 112 is formed at intervals in the longitudinal direction of the plug holding portion 104. Each of the plurality of third plug recessed portions 112 is formed at a position corresponding to each of the plurality of first plug terminals 105 in the longitudinal direction of the plug holding portion 104.

When the front surface (outer surface) of the plug housing 101 is covered with the insulating member 108, the plurality of first plug recessed portions 109 of the plug housing 101 and the plurality of third plug recessed portions 112 of the insulating member 108 form a plurality of fourth plug recessed portions 113. The fourth plug recessed portion 113 is in a long groove shape extending long in the lateral direction of the plug holding portion 104.

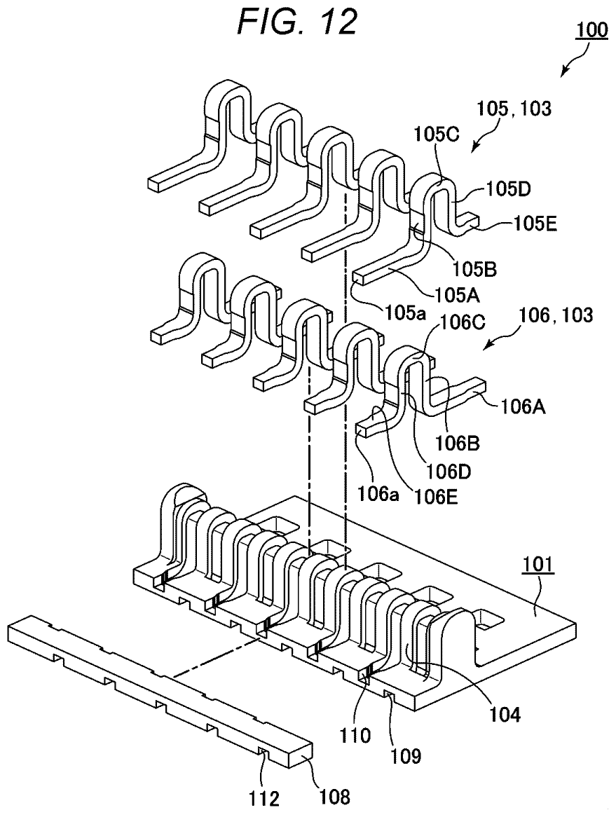

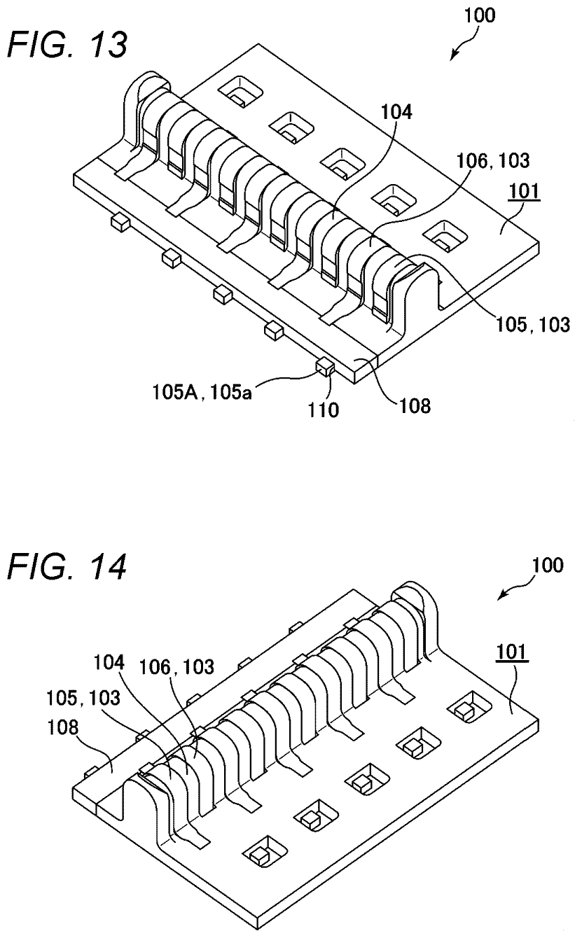

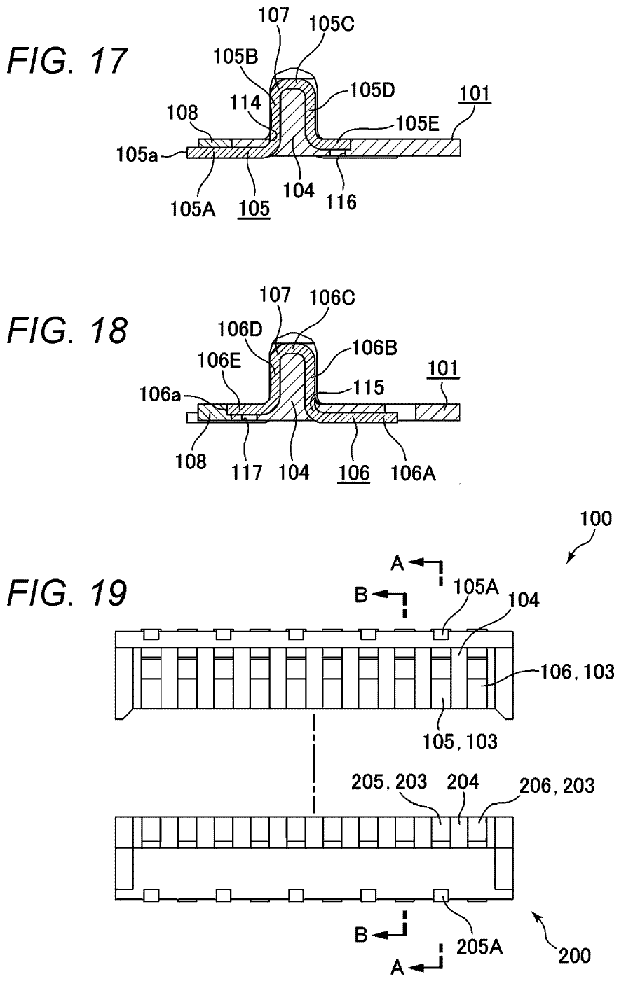

As shown in FIGS. 13 to 15, a first plug penetrating portion 114 penetrating the plug housing 101 in the Z-axis direction is connected to the bottom surface of each of the plurality of fourth plug recessed portions 113 (see FIG. 17 and the like). In plan view in the Z-axis direction, each of the plurality of fourth plug recessed portions 113 is provided at a position corresponding to the first plug terminal 105. Each of the plurality of fourth plug recessed portions 113 linearly extends outward of the plug connector 100 from a portion formed with the first plug penetrating portion 114 in the lateral direction of the plug holding portion 104, linearly penetrates the insulating member 108, and is opened in the outer surface of the plug connector 100 of which the insulating member 108 is covered.

A tip end side (outer) portion of the first plug terminal 105 with respect to a portion held by the plug holding portion 104 is inserted into the first plug penetrating portion 114 in the Z-axis direction, is drawn to the lower surface of the plug housing 101, and is housed in the fourth plug recessed portion 113.

The portion of the first plug terminal 105 housed in the fourth plug recessed portion 113 is flush with the upper surface of the plug housing 101, and as described later, when the second circuit board is mounted on the upper surface of the plug housing 101, functions as a mount portion 105A on which the second circuit board is mounted.

The tip end portion of the first plug terminal 105 on the outside of the plug connector 100 with respect to the portion held by the plug holding portion 104 protrudes outward of the plug connector 100 from the insulating member 108 in the lateral direction of the plug holding portion 104, and is exposed on the insulating member 108. The tip end surface 106a of a portion of the second plug terminal 106 on the outside of the plug connector 100 with respect to a portion held by the plug holding portion 104 is covered with the insulating member 108.

A second plug penetrating portion 115 penetrating the plug housing 101 in the Z-axis direction is connected to the bottom surface of each of the plurality of third plug recessed portions 112. In plan view in the Z-axis direction, each of the plurality of third plug recessed portions 112 is provided at a position corresponding to the second plug terminal 106. Each of the plurality of second plug recessed portions 110 linearly extends inward of the plug connector 100 from a portion formed with the second plug penetrating portion 115 in the lateral direction of the plug holding portion 104.

A tip end side (inner) portion of the second plug terminal 106 with respect to the portion held by the plug holding portion 104 is inserted into the second plug penetrating portion 115 in the Z-axis direction, is drawn to the lower surface of the plug housing 101, and is housed in the third plug recessed portions 112.

The portion of the second plug terminal 106 housed in the third plug recessed portion 112 is flush with the upper surface of the plug housing 101, and as described later, when the second circuit board is mounted on the upper surface of the plug housing 101, functions as a mount portion 106A on which the second circuit board is mounted.

As shown in FIGS. 16 and 17, the first plug terminal 105 has the mount portion 105A, a first leg portion 105B, a top portion 105C, a second leg portion 105D, and a non-mount portion 105E. The first leg portion 105B, the top portion 105C, and the second leg portion 105D form the fitting raised portion 107 substantially in the inverted U-shape protruding in the Z-axis direction.

The mount portion 105A is exposed on the plug housing 101 through the fourth plug recessed portion 113 formed in the lower surface of the plug housing 101, and is mountable on the first circuit board by soldering. The first leg portion 105B is coupled to the mount portion 105A, and extends in the Z-axis direction from the mount portion 105A. The top portion 105C is coupled to the first leg portion 105B, and extends inward of the plug connector 100 from the first leg portion 105B along the lateral direction of the plug holding portion 104. The second leg portion 105D is coupled to the top portion 105C, and extends in the Z-axis direction from the top portion 105C.

The non-mount portion 105E is coupled to the second leg portion 105D, and extends inward of the plug connector 100 from the second leg portion 105D along the lateral direction of the plug holding portion 104. The non-mount portion 105E is located apart from the first circuit board than the mount portion 105A in the Z-axis direction. The non-mount portion 105E is exposed on the plug housing 101 through a third plug penetrating portion 116 formed in the plug housing 101. However, a gap is interposed between the non-mount portion 105E and the first circuit board in the Z-axis direction, and therefore, the non-mount portion 105E is not mounted on the first circuit board.

As shown in FIGS. 16 and 18, the second plug terminal 106 has the mount portion 106A, a first leg portion 106B, a top portion 106C, a second leg portion 106D, and a non-mount portion 106E. The first leg portion 106B, the top portion 106C, and the second leg portion 106D form the fitting raised portion 107 substantially in the inverted U-shape protruding in the Z-axis direction.

The mount portion 106A is exposed on the plug housing 101 through the third plug recessed portion 112 formed in the lower surface of the plug housing 101, and is mounted on the first circuit board by soldering. The first leg portion 106B is coupled to the mount portion 106A, and extends in the Z-axis direction from the mount portion 106A. The top portion 106C is coupled to the first leg portion 106B, and extends outward of the plug connector 100 from the first leg portion 106B along the lateral direction of the plug holding portion 104. The second leg portion 106D is coupled to the top portion 106C, and extends in the Z-axis direction from the top portion 106C.

The non-mount portion 106E is coupled to the second leg portion 106D, and extends outward of the plug connector 100 from the second leg portion 106D in the lateral direction of the plug holding portion 104. The non-mount portion 106E is located apart from the first circuit board than the mount portion 106A in the Z-axis direction. The non-mount portion 106E is exposed on the plug housing 101 through a fourth plug penetrating portion 117 formed in the plug housing 101. However, a gap is interposed between the non-mount portion 106E and the first circuit board in the Z-axis direction, and therefore, the non-mount portion 106E is not mounted on the first circuit board.

As described above, the first plug terminals 105 and the second plug terminals 106 are arranged at intervals in the longitudinal direction of the plug holding portion 104. The first plug terminal 105 has, at the outer tip end thereof, the mount portion 105A (tip end surface 105a), and at the inner tip end thereof, has the non-mount portion 105E (see FIG. 17). The second plug terminals 106 has, at the outer tip end thereof, the non-mount portion 106E (tip end surface 106a), and at the inner tip end thereof, has the mount portion 106A (see FIG. 18). The mount portions 105A of the first plug terminals 105 and the non-mount portions 106E of the second plug terminals 106 are adjacent to each other at intervals in the longitudinal direction of the plug holding portion 104, and extend outward of the receptacle connector 200 from the receptacle holding portion 204 in the lateral direction of the plug holding portion 104.

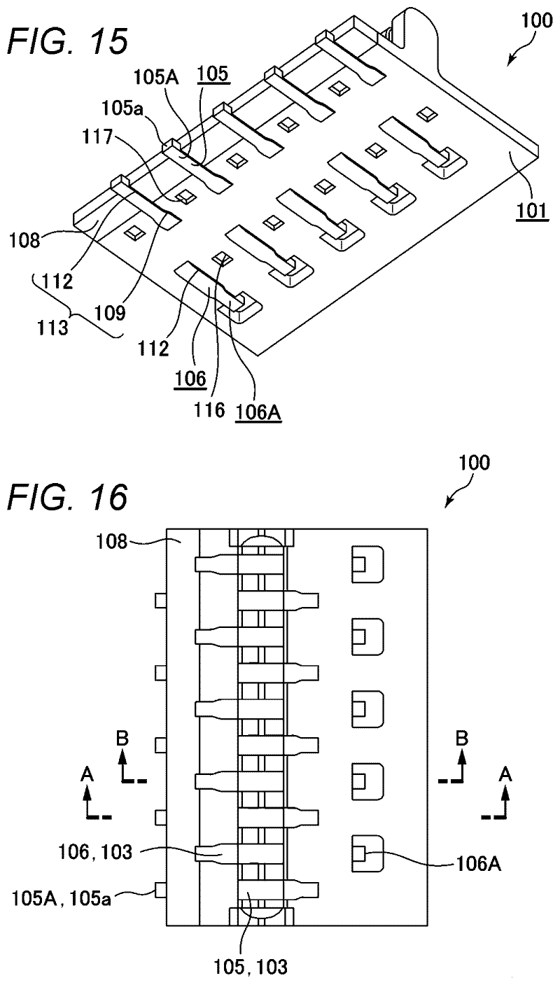

The tip end surface 105a of the first plug terminal 105 penetrates the insulating member 108 through the fourth plug recessed portion 113, and is exposed on the outer surface side of the plug connector 100. The mount portion 105A is exposed on the lower surface side of the plug connector 100 through the fourth plug recessed portion 113. Note that the outer surface of the plug connector 100 is the outer surface of the plug housing 101, specifically the outer surface of the plug housing 101 orthogonal to the lateral direction of the plug holding portion 104 (see FIG. 15 and the like).

The tip end surface 106a of the second plug terminal 106 is covered with the insulating member 108 on such an outer surface side of the plug connector 100. The non-mount portion 106E of the second plug terminal 106 has the gap between the non-mount portion 106E and the second circuit board in the Z-axis direction in a state of the plug connector 100 being mounted on the second circuit board, and is formed so as not to contact the second circuit board (see FIG. 17 and the like).

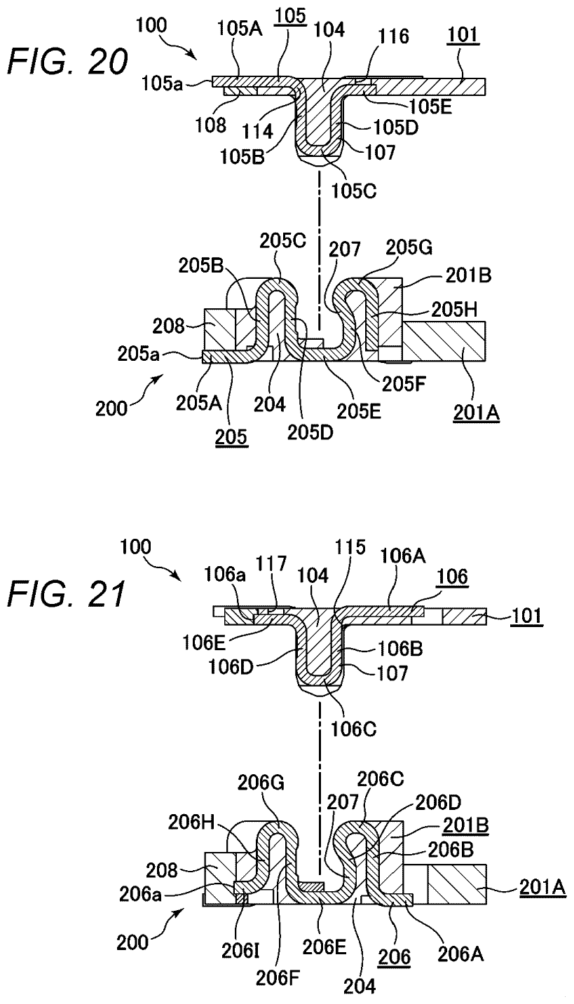

As shown in FIGS. 19 to 21, when the receptacle connector 200 and the plug connector 100 are fitted in each other, the first receptacle terminals 205 of the receptacle connector 200 and the first plug terminals 105 of the plug connector 100 face each other in the Z-axis direction, and the second receptacle terminals 206 of the receptacle connector 200 and the second plug terminals 106 of the plug connector 100 face each other in the Z-axis direction. While the first receptacle terminals 205 of the receptacle connector 200 are elastically deformed, the fitting raised portions 107 of the first plug terminals 105 of the plug connector 100 are housed in the fitting recessed portions 207 of the first receptacle terminals 205 of the receptacle connector 200. Moreover, while the second receptacle terminals 206 of the receptacle connector 200 are elastically deformed, the fitting raised portions 107 of the second plug terminals 106 of the plug connector 100 are housed in the fitting recessed portions 207 of the second receptacle terminals 206 of the receptacle connector 200.

Next, a method for manufacturing the receptacle connector 200 will be described with reference to the drawings.

As shown in FIG. 22, when the receptacle connector 200 is manufactured, the plurality of first receptacle terminals 205 and the plurality of second receptacle terminals 206 are first alternately disposed at intervals. In this case, the plurality of first receptacle terminals 205 and the plurality of second receptacle terminals 206 are disposed so as to extend long in parallel in the same direction.

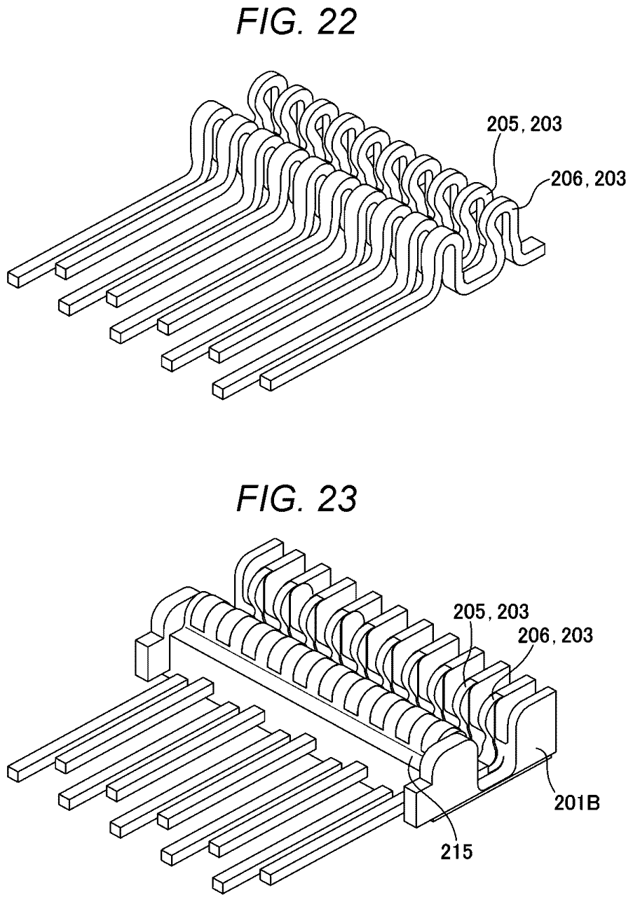

Next, as shown in FIG. 23, the second receptacle housing unit 201B is insert-molded as a first inserting molding. In this manner, the first receptacle terminals 205 and the second receptacle terminals 206 are held by the second receptacle housing unit 201B. In this case, the tip end portions of the first receptacle terminals 205 and the tip end portions of the second receptacle terminals 206 protrude from the front surface (outer surface) of the front wall portion 215 of the second receptacle housing unit 201B.

Next, as shown in FIG. 24, the tip end portions of the second receptacle terminals 206 are cut substantially along the front surface of the front wall portion 215 of the second receptacle housing unit 201B. In an example shown in FIG. 24, the non-mount portions 206I (tip end surfaces 206a) of the second receptacle terminals 206 slightly protrude from the front surface of the front wall portion 215 of the second receptacle housing unit 201B.

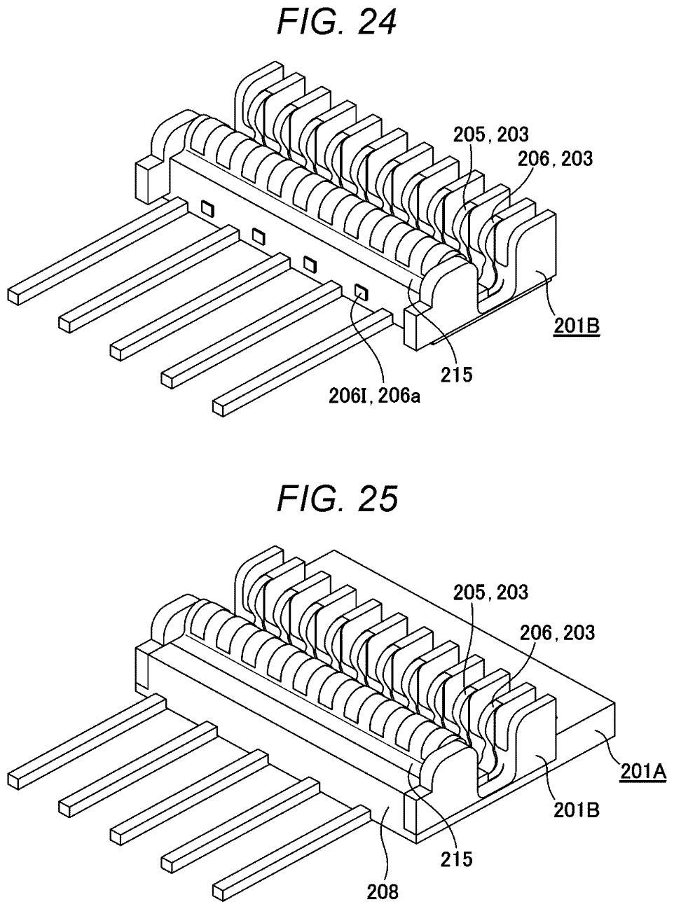

Next, as shown in FIG. 25, the receptacle housing 201 is insert-molded as a second insert molding, and the front surface of the front wall portion 215 of the second receptacle housing unit 201B is covered with the insulating member 208. In this manner, the tip end surfaces 206a of the second receptacle terminals 206 are covered with the insulating member 208. The tip end portions of the first receptacle terminals 205 protrude from the front surface of the insulating member 208.

Next, as shown in FIG. 26, the tip end portions of the first receptacle terminals 205 protruding from the insulating member 208 are cut substantially along the front surface of the insulating member 208. In an example shown in FIG. 26, the mount portions 205A (tip end surfaces 205a) of the first receptacle terminals 205 slightly protrude from the front surface of the insulating member 208.

Next, a method for manufacturing the plug connector 100 will be described with reference to the drawings.

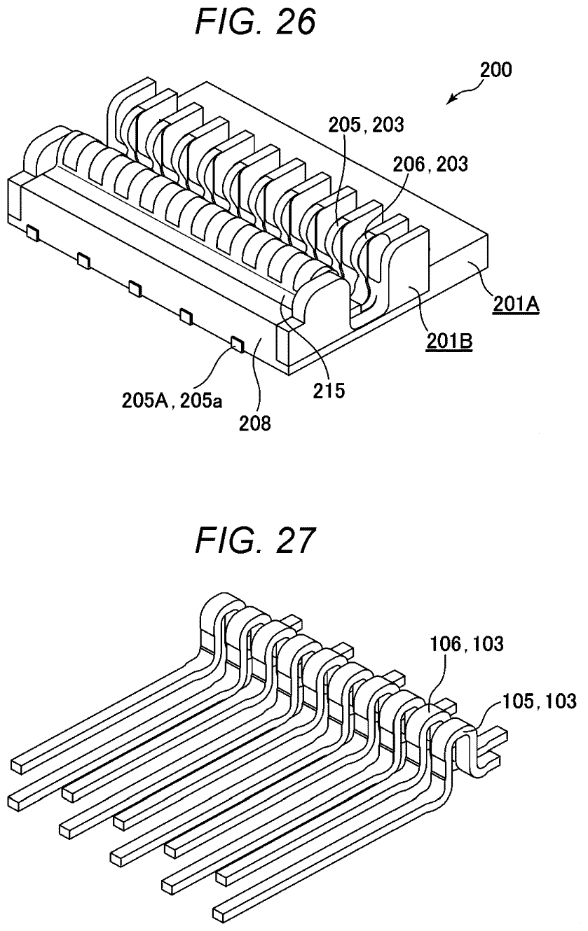

As shown in FIG. 27, when the plug connector 100 is manufactured, the plurality of first plug terminals 105 and the plurality of second plug terminals 106 are first alternately disposed at intervals. In this case, the plurality of first plug terminals 105 and the plurality of second plug terminals 106 are disposed so as to extend long in parallel in the same direction.

Next, as shown in FIG. 28, the plug housing 101 is insert-molded as a first insert molding. In this manner, the first plug terminals 105 and the second plug terminals 106 are held by the plug housing 101. In this case, the tip end portions of the first plug terminals 105 and the tip end portions of the second plug terminals 106 protrude from the front surface (outer surface) of the plug housing 101.

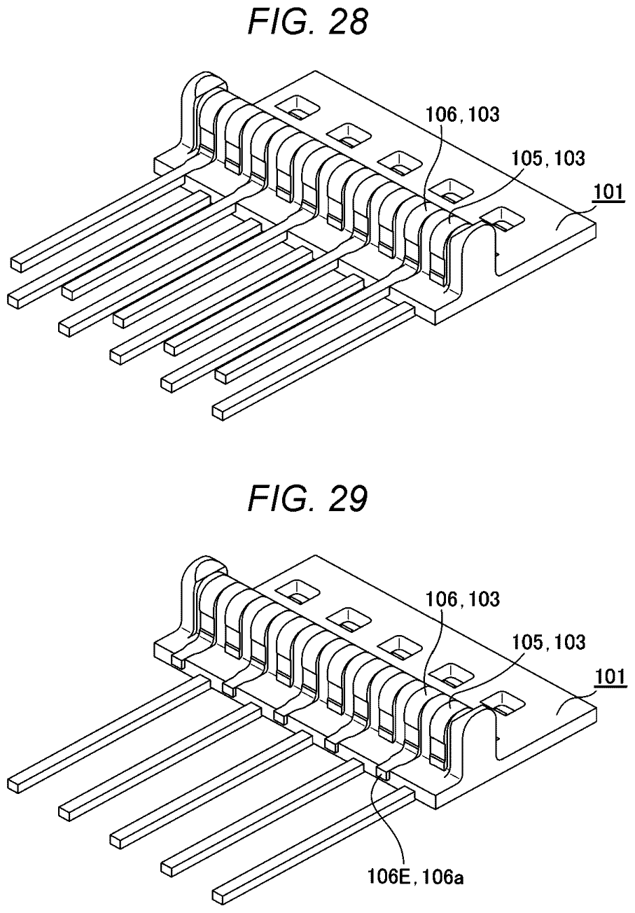

Next, as shown in FIG. 29, the tip end portions of the second plug terminals 106 are cut substantially along the front surface of the plug housing 101. In an example shown in FIG. 29, the non-mount portions 106E (tip end surfaces 106a) of the second plug terminals 106 slightly protrude from the front surface of the plug housing 101.

Next, as shown in FIG. 30, the insulating member 108 is insert-molded as a second insert molding, and the front surface of the plug housing 101 is covered with the insulating member 108. In this manner, the tip end surfaces 106a of the second plug terminals 106 are covered with the insulating member 108. The tip end portions of the first plug terminals 105 protrude from the front surface of the insulating member 108.

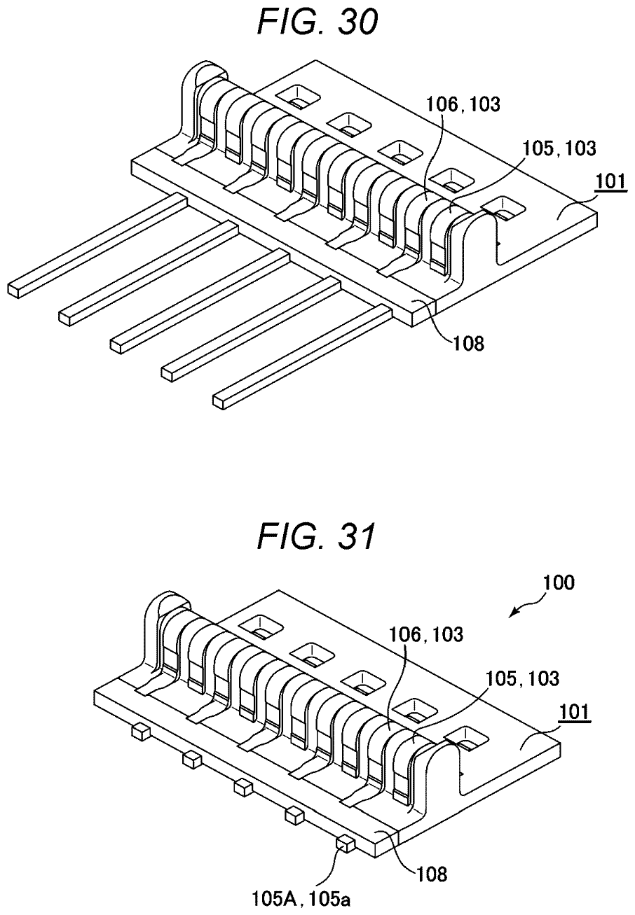

Next, as shown in FIG. 31, the tip end portions of the first plug terminals 105 protruding from the front end surface of the insulating member 108 are cut substantially along the front end surface of the insulating member 108. In an example shown in FIG. 31, the mount portions 105A (tip end surfaces 105a) of the first plug terminals 105 slightly protrude from the front surface of the insulating member 108.

As described above, the present disclosure has the following aspects, and can obtain the following effects.
(1) In the receptacle connector 200, the insulating member 208 is interposed between the mount portion 205A of the first receptacle terminal 205 and the non-mount portion 206I of the second receptacle terminal 206, which are adjacent to each other in the longitudinal direction of the receptacle holding portion 204. Thus, in a case where the mount portion 205A of the first receptacle terminal 205 is mounted on the first circuit board by soldering, occurrence of short circuit between the mount portion 205A of the first receptacle terminal 205 and the non-mount portion 206I of the second receptacle terminal 206 can be reduced. Moreover, even when a metal material showing a high ionization tendency is used as the first receptacle terminal 205 and the second receptacle terminal 206, occurrence of ion migration between the first receptacle terminal 205 and the second receptacle terminal 206 is reduced by the insulating member 208. Thus, the versatility of the receptacle connector 200 can be enhanced.
(2) In the receptacle connector 200, the mount portion 205A of the first receptacle terminal 205 and the non-mount portion 206I of the second receptacle terminal 206 are different from each other in the amount of protrusion from the receptacle holding portion 204. The tip end surface 206a of one of the mount portion 205A of the first receptacle terminal 205 or the non-mount portion 206I of the second receptacle terminal 206, which is relatively smaller in the amount of protrusion from the receptacle holding portion 204, is covered with the insulating member 208, and the tip end surface 205a of the other one which is relatively greater in the amount of protrusion from the receptacle holding portion 204 is exposed. In this manner, the mount portion 205A of the first receptacle terminal 205 and the non-mount portion 206I of the second receptacle terminal 206 are different from each other in the amount of protrusion to the outside of the connector from the receptacle holding portion 204 along the lateral direction of the receptacle holding portion 204, and therefore, the mount portion 205A of the first receptacle terminal 205 and the non-mount portion 206I of the second receptacle terminal 206 can be provided with the gap therebetween. The insulating member 208 is interposed between the mount portion 205A of the first receptacle terminal 205 and the non-mount portion 206I of the second receptacle terminal 206, which are provided with the gap therebetween in the direction of protrusion from the receptacle holding portion 204, and therefore, the occurrence of the short circuit between the mount portion 205A of the first receptacle terminal 205 and the non-mount portion 206I of the second receptacle terminal 206 can be more properly reduced.
(3) In the receptacle connector 200, the amount of protrusion to the outside of the receptacle connector 200 from the receptacle holding portion 204 along the lateral direction of the receptacle holding portion 204 is greater in the mount portion 205A of the first receptacle terminal 205 mounted on the first circuit board than in the non-mount portion 206I of the second receptacle terminal 206 not mounted on the first circuit board. With this configuration, the occurrence of the short circuit between the mount portion 205A of the first receptacle terminal 205 and the non-mount portion 206I of the second receptacle terminal 206 can be more properly reduced.
(4) In the receptacle connector 200, the second receptacle housing unit 201B has the third receptacle recessed portion 219 opened in the surface facing the first circuit board in a state of the receptacle connector 200 being mounted on the first circuit board, and the third receptacle recessed portion 219 houses the mount portion 205A of the first receptacle terminal 205. With this configuration, the amount of protrusion of the mount portion 205A of the first receptacle terminal 205 in the thickness direction (Z-axis direction) thereof from the surface of the receptacle connector 200 facing the first circuit board is reduced. Thus, the receptacle connector 200 can be reduced in size.
(5) In the receptacle connector 200, the third receptacle recessed portion 219 is connected to the first receptacle penetrating portion 216 penetrating the second receptacle housing unit 201B in the thickness direction (Z-axis direction) thereof. With this configuration, the first receptacle terminal 205 held by the second receptacle housing unit 201B is drawn to the surface of the receptacle connector 200 facing the first circuit board through the first receptacle penetrating portion 216. Thus, the receptacle connector 200 can be further reduced in size.
(6) In the receptacle connector 200, the third receptacle recessed portion 219 is opened in both the surface facing the first circuit board in a state of the receptacle connector 200 being mounted on the first circuit board and the outer surface of the insulating member 208. With this configuration, the first receptacle terminal 205 is housed in the third receptacle recessed portion 219 and is drawn to the outer surface of the insulating member 208, and therefore, the receptacle connector 200 can be further reduced in size.
(7) In the plug connector 100, the insulating member 108 is interposed between the mount portion 105A of the first plug terminal 105 and the non-mount portion 106E of the second plug terminal 106. Thus, in a case where the mount portion 105A of the first plug terminal 105 is mounted on the first circuit board by soldering, occurrence of short circuit between the mount portion 105A of the first plug terminal 105 and the non-mount portion 106E of the second plug terminal 106 can be reduced. Moreover, even when a metal material showing a high ionization tendency is used as the first plug terminal 105 and the second plug terminal 106, occurrence of ion migration between the first plug terminal 105 and the second plug terminal 106 is reduced by the insulating member 108. Thus, the versatility of the plug connector 100 can be enhanced.
(8) In the plug connector 100, the mount portion 105A of the first plug terminal 105 and the non-mount portion 106E of the second plug terminal 106 are different from each other in the amount of protrusion from the plug holding portion 104. The tip end surface 106a of one of the mount portion 105A of the first plug terminal 105 or the non-mount portion 106E of the second plug terminal 106, which is relatively smaller in the amount of protrusion from the plug holding portion 104, is covered with the insulating member 108, and the tip end surface 105a of the other one which is relatively greater in the amount of protrusion from the plug holding portion 104 is exposed. In this manner, the amount of protrusion from the plug holding portion 104 is different between these portions, and therefore, the mount portion 105A of the first plug terminal 105 and the non-mount portion 106E of the second plug terminal 106 can be provided with the gap therebetween. The insulating member 108 is interposed between the mount portion 105A of the first plug terminal 105 and the non-mount portion 106E of the second plug terminal 106, which are provided with the gap therebetween in the direction of protrusion from the plug holding portion 104, and therefore, the occurrence of the short circuit between the mount portion 105A of the first plug terminal 105 and the non-mount portion 106E of the second plug terminal 106 can be more properly reduced.
(9) In the plug connector 100, the amount of protrusion to the outside of the plug connector 100 from the plug holding portion 104 along the lateral direction of the plug holding portion 104 is greater in the mount portion 105A of the first plug terminal 105 mounted on the second circuit board than in the non-mount portion 106E of the second plug terminal 106 not mounted on the second circuit board. With this configuration, the occurrence of the short circuit between the mount portion 105A of the first plug terminal 105 and the non-mount portion 106E of the second plug terminal 106 can be more properly reduced.
(10) In the plug connector 100, the plug housing 101 has the fourth plug recessed portion 113 opened in the surface facing the second circuit board in a state of the plug connector 100 being mounted on the first circuit board, and the fourth plug recessed portion 113 houses the mount portion 105A of the first plug terminal 105. With this configuration, the amount of protrusion of the mount portion 105A of the first plug terminal 105 in the thickness direction (Z-axis direction) thereof from the surface of the plug connector 100 facing the second circuit board is reduced. Thus, the plug connector 100 can be reduced in size.
(11) In the plug connector 100, the fourth plug recessed portion 113 is connected to the first plug penetrating portion 114 penetrating the plug housing 101 in the thickness direction thereof. The first plug terminal 105 held by the plug holding portion 104 is drawn to the surface of the plug connector 100 facing the second circuit board through the first plug penetrating portion 114. Thus, the plug connector 100 can be further reduced in size.
(12) In the plug connector 100, the fourth plug recessed portion 113 is opened in both the surface facing the second circuit board in a state of the plug connector 100 being mounted on the second circuit board and the outer surface of the insulating member 108. With this configuration, the first plug terminal 105 is housed in the fourth plug recessed portion 113 and is drawn to the outer surface of the insulating member 108, and therefore, the plug connector 100 can be further reduced in size.

The above-described embodiment can also be implemented in the following forms.

In the above-described embodiment, the fourth plug recessed portion 113 of the plug connector 100 is not necessarily opened in the outer surface of the insulating member 108.

In the above-described embodiment, the plug connector 100 may be configured such that the first plug terminal 105 held by the plug holding portion 104 is drawn to the surface of the plug connector 100 facing the second circuit board after passing by the side of the plug housing 101.

In the above-described embodiment, the plug housing 101 of the plug connector 100 does not necessarily have the fourth plug recessed portion 113 for housing the mount portion 105A of the first plug terminal 105.

In the above-described embodiment, in the plug connector 100, the amount of protrusion from the plug holding portion 104 to the outside of the plug connector 100 along the lateral direction of the plug holding portion 104 may be smaller in the mount portion 105A of the first plug terminal 105 than the non-mount portion 106E of the second plug terminal 106.

In the above-described embodiment, in the plug connector 100, the amount of protrusion from the plug holding portion 104 to the outside of the plug connector 100 along the lateral direction of the plug holding portion 104 may be the same between the mount portion 105A of the first plug terminal 105 and the non-mount portion 106E of the second plug terminal 106.

In the above-described embodiment, in the plug connector 100, the configuration in which the insulating member 108 is interposed between the mount portions 105A of the first plug terminals 105 and the non-mount portions 106E of the second plug terminals 106 is not limited to that in the above-described embodiment. For example, the tip end portions of the second plug terminals 106 exposed on the plug housing 101 may be locally covered with the insulating member 108, and in this manner, the insulating member 108 may be interposed between the mount portions 105A of the first plug terminals 105 and the non-mount portions 106E of the second plug terminals 106.

In the above-described embodiment, in the receptacle connector 200, the third receptacle recessed portion 219 is not necessarily opened in the outer surface of the first receptacle housing unit 201A.

In the above-described embodiment, the receptacle connector 200 may be configured such that the first receptacle terminal 205 held by the receptacle holding portion 204 is drawn to the surface of the receptacle connector 200 facing the first circuit board after passing by the side of the first receptacle housing unit 201A.

In the above-described embodiment, in the receptacle connector 200, the receptacle housing 201 does not necessarily have the third receptacle recessed portions 219 for housing the mount portions 205A of the first receptacle terminals 205.

In the above-described embodiment, in the receptacle connector 200, the amount of protrusion from the receptacle holding portion 204 to the outside of the receptacle connector 200 along the lateral direction of the receptacle holding portion 204 may be smaller in the mount portion 205A of the first receptacle terminal 205 than the non-mount portion 206I of the second receptacle terminal 206.

In the above-described embodiment, in the receptacle connector 200, the amount of protrusion from the receptacle holding portion 204 to the outside of the receptacle connector 200 along the lateral direction of the receptacle holding portion 204 may be the same between the mount portion 205A of the first receptacle terminal 205 and the non-mount portion 206I of the second receptacle terminal 206.

In the above-described embodiment, in the receptacle connector 200, the configuration in which the insulating member 208 is interposed between the mount portions 205A of the first receptacle terminals 205 and the non-mount portions 206I of the second receptacle terminals 206 is not limited to the example described in the above-described embodiment. For example, the tip end portions of the second receptacle terminals 206 exposed on the second receptacle housing unit 201B may be locally covered with the insulating member 208, and in this manner, the insulating member 208 may be interposed between the mount portions 205A of the first receptacle terminals 205 and the non-mount portions 206I of the second receptacle terminals 206.

Note that each embodiment of the present disclosure is not independent, but can be implemented as necessary in combination. Moreover, the above-described embodiments are examples for describing the present disclosure, and the present disclosure is not limited to these embodiments. The present disclosure can be implemented in various forms without departing from the gist thereof.

The foregoing detailed description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is:

1. A connector mounted on a circuit board, comprising:
a first terminal and a second terminal; and
a housing having a holding portion for holding the first terminal and the second terminal,
wherein the first terminal and the second terminal are arranged in a longitudinal direction of the holding portion, and extend in a lateral direction of the holding portion,
the first terminal includes a first mount portion, the second terminal includes a second mount portion, and the first mount portion and the second mount portion are mounted on the circuit board in a state of the connector being mounted on the circuit board,
the second terminal further includes a non-mount portion, and the non-mount portion is not mounted on the circuit board in the state of the connector being mounted on the circuit board,
the first mount portion of the first terminal and the non-mount portion of the second terminal extend outward of the connector from the holding portion along the lateral direction, and
the housing has an insulating member, and the insulating member is interposed between the first mount portion of the first terminal and the non-mount portion of the second terminal, which are adjacent to each other in the longitudinal direction.

2. The connector according to claim 1, wherein
the first mount portion of the first terminal and the non-mount portion of the second terminal are different from each other in an amount of protrusion from the holding portion to an outside of the connector along the lateral direction, and
a tip end surface of one of the first mount portion of the first terminal or the non-mount portion of the second terminal, which is relatively smaller in the amount of protrusion is covered with the insulating member, and a tip end surface of the other one which is relatively greater in the amount of protrusion is exposed.

3. The connector according to claim 2, wherein
the amount of protrusion of the first mount portion of the first terminal is greater than the amount of protrusion of the non-mount portion of the second terminal.

4. The connector according to claim 1, wherein
the housing has a recessed portion, and
the recessed portion is opened in a surface of the housing facing the circuit board in the state of the connector being mounted on the circuit board, and houses the first mount portion of the first terminal.

5. The connector according to claim 4, wherein
the housing has a penetrating portion penetrating the housing in a thickness direction, and
the recessed portion is connected to the penetrating portion.

6. The connector according to claim 4, wherein
the recessed portion is opened in both the surface of the housing facing the circuit board in the state of the connector being mounted on the circuit board and an outer surface of the housing orthogonal to the lateral direction.

7. A connector assembly comprising:
the connector according to claim 1; and
a partner connector fitted in the connector.

8. A method for manufacturing a connector mounted on a circuit board, comprising:
holding, by a holding portion of a housing, a first terminal and a second terminal such that the first terminal and the second terminal are arranged in a longitudinal direction of the holding portion; and
interposing an insulating member between a mount portion of the first terminal extending outward of the connector from the holding portion along a lateral direction of the holding portion and mounted on the circuit board in a state of the connector being mounted on the circuit board and a non-mount portion of the second terminal extending outward of the connector from the holding portion along the lateral direction of the holding portion and not mounted on the circuit board in the state of the connector being mounted on the circuit board.

9. The method for manufacturing the connector according to claim 8, wherein
the interposing the insulating member between the mount portion of the first terminal and the non-mount portion of the second terminal includes
cutting, along an outer surface of the housing orthogonal to the lateral direction, one of the mount portion of the first terminal or the non-mount portion of the second terminal, which is relatively smaller in an amount of protrusion from the holding portion to an outside of the connector along the lateral direction,
covering the outer surface of the housing with the insulating member, and
cutting, along an outer surface of the insulating member, the other one of the mount portion of the first terminal or the non-mount portion of the second terminal, which is relatively greater in the amount of protrusion form the holding portion.

10. A plug connector mounted on a circuit board, comprising
a first plug terminal and a second plug terminal; and
a plug housing having a plug holding portion for holding the first plug terminal and the second plug terminal,
wherein the first plug terminal and the second plug terminal are arranged in a longitudinal direction of the plug holding portion, and extend in a lateral direction of the plug holding portion,
the first plug terminal includes a first mount portion and a first non-mount portion, the second plug terminal includes a second mount portion and a second non-mount portion, the first mount portion and the second mount portion are mounted on the circuit board in a state of the plug connector being mounted on the circuit board, and the first non-mount portion and the second non-mount portion are not mounted on the circuit board in the state of the plug connector being mounted on the circuit board,
the first mount portion of the first plug terminal and the second non-mount portion of the second plug terminal extend outward of the plug connector from the plug holding portion along the lateral direction, and
the plug housing has an insulating member, and the insulating member covers a tip end surface of the second non-mount portion of the second plug terminal and is interposed between the first mount portion of the first plug terminal and the second non-mount portion of the second plug terminal, which are adjacent to each other in the longitudinal direction.

11. A receptacle connector mounted on a circuit board, comprising
a first receptacle terminal and a second receptacle terminal; and
a receptacle housing having a receptacle holding portion for holding the first receptacle terminal and the second receptacle terminal,
wherein the first receptacle terminal and the second receptacle terminal are arranged in a longitudinal direction of the receptacle holding portion, and extend in a lateral direction of the receptacle holding portion,
the first receptacle terminal includes a first mount portion, the second receptacle terminal includes a second mount portion, and the first mount portion and the second mount portion are mounted on the circuit board in a state of the receptacle connector being mounted on the circuit board,
the second receptacle terminal further includes a non-mount portion, and the non-mount portion is not mounted on the circuit board in the state of the receptacle connector being mounted on the circuit board,
the first mount portion of the first receptacle terminal and the non-mount portion of the second receptacle terminal extend outward of the receptacle connector from the receptacle holding portion along the lateral direction, and
the receptacle housing has an insulating member, and the insulating member covers a tip end surface of the non-mount portion of the second receptacle terminal and is interposed between the first mount portion of the first receptacle terminal and the non-mount portion of the second receptacle terminal, which are adjacent to each other in the longitudinal direction.
